(19) United States
(12) Patent Application Publication
(10) Pub. No.: US 2016/0276887 A1
(43) Pub. Date: Sep. 22, 2016

(54) STATOR, ROTATING ELECTRIC MACHINE, VEHICLE, AND STATOR MANUFACTURING METHOD

(71) Applicant: Nidec Copal Corporation, Tokyo (JP)

(72) Inventors: Masakazu WATANABE, Tokyo (JP); Yoshinori FUKASAKU, Tokyo (JP); Masato IWASE, Tokyo (JP); Koki KUNII, Koriyama-Shi (JP); Hirofumi NAGASAWA, Tokyo (JP)

(73) Assignee: Nidec Copal Corporation, Tokyo (JP)

(21) Appl. No.: 15/074,648

(22) Filed: Mar. 18, 2016

(30) Foreign Application Priority Data
Mar. 19, 2015 (JP) 2015-056927

(51) Int. Cl. H02K 3/12; H02K 15/02; B60L 11/18; H02K 3/32

(52) U.S. Cl. CPC H02K 3/12; H02K 3/32; H02K 15/026; B60L 11/1803

(57) ABSTRACT

A stator provided with coils that are interconnected by distributed windings on a stator core of a rotating electric machine having: a stator core module comprising a stator core wherein one part of a linear conductor portion of the coil is disposed in a slot; and a mold end, formed through insulator molding of a coil end portion of the coil, wherein: the linear conductor portion of the stator core module comprises a first junction portion at a conductor end portion that is disposed protruding from the stator core toward the mold end side; and the coil end portion of the mold end comprises a second junction portion at a conductor portion disposed protruding from an end portion of the insulator mold toward the stator core module side; having a structure wherein the first junction portion and the second junction portion are joined.

### CROSS-REFERENCE TO RELATED APPLICATION

The present application claims priority to Japanese Patent Application No. 2015-056927 filed Mar. 19, 2015. The application is incorporated herein by reference in its entirety.

### FIELD OF TECHNOLOGY

The present invention relates to a stator, a rotating electric machine, a vehicle, and a stator manufacturing method.

### BACKGROUND

A known stator for a rotating electric machine has a stator core and stator coils that are installed in slots in the stator core (referencing, for example, Japanese Unexamined Patent Application Publication No. 2001-178053).

The stator coils of the stator described in Japanese Unexamined Patent Application Publication No. 2001-178053 are structured from layered coil pieces, wherein two thin plate-shaped conductors that are shaped in straight lines are layered together, formed through monolithic mold forming using an insulating resin, with connecting end portions formed at both end portions of these conductors, and first and second connecting coil pieces that are formed with thin plate-shaped conductors layered together through monolithic mold forming using an insulating resin, where one end portion of each of the thin plate-shaped conductors of the aforementioned layered coil pieces that are each inserted into respective slots in the aforementioned stator core, held between tooth portions, are held between the aforementioned tooth portions to be connected by the thin plate-shaped conductors of the aforementioned first connecting coil pieces, and the other end portions are held between the aforementioned tooth portions and are connected by thin plate-shaped conductors of the aforementioned second connecting coils so as to be shifted in the radial direction by one layer of the thin plate-shaped conductors that are layered in the radial direction of the stator coil, to form stator coils that are coiled onto the aforementioned tooth portions.

However, concentrated winding and distributed winding are known as winding formats for coils of stators. A rotating electric machine that is equipped with a distributed winding stator has a higher output torque or higher electrical power generation when compared with a rotating machine that is provided with a concentrated winding stator.

### SUMMARY OF THE INVENTION

However, a stator with a distributed winding requires a coil end portion that is relatively large. Because of this, it is desirable to reduce the size of the coil end portion (to reduce the profile).

Moreover, with a distributed winding stator the winding format is complex, making manufacturing difficult. Because of this, a distributed winding stator that can be manufactured easily is desirable.

Moreover, it is not possible to manufacture a stator with a distributed winding that is complex, such as lap winding or wave winding, using the stator coil manufacturing method set forth in Japanese Unexamined Patent Application Publication No. 2001-178053.

In the present invention, the handling of such problems is an example of the problem to be solved. Objects of the present invention are the provision of a stator of a simple structure wherein the height of the coil end portion is low, the provision of a rotating electric machine provided with this stator, the provision of a vehicle provided with this rotating electric machine, the provision of a method for manufacturing a stator wherein manufacturing is easy, and the like.

In order to achieve such an object, the stator of the present invention is equipped with at least the following structures:

a stator provided with coils that are interconnected by distributed windings on a stator core of a rotating electric machine having:

a stator core module comprising a stator core wherein one part of a linear conductor portion of the coil is disposed in a slot; and

a mold end, formed through insulator molding of a coil end portion of the coil, wherein:

the linear conductor portion of the stator core module comprises a first junction portion at a conductor end portion that is disposed protruding from the stator core toward the mold end side; and

the coil end portion of the mold end comprises a second junction portion at a conductor portion disposed protruding from an insulator toward the stator core module side;

having a structure wherein the first junction portion and the second junction portion are joined.

The rotating electric machine according to the present invention is characterized by the provision of the stator according to the invention set forth above.

The vehicle according to the present invention is characterized by the provision of the rotating electric machine according to the invention set forth above.

The method for manufacturing the stator according to the present invention is provided with at least the following structures:

a manufacturing method for a stator provided with coils that are interconnected by distributed windings on a stator core of a rotating electric machine having:

the stator has a stator core module that comprises a stator core wherein individual parts of linear conductor portions of coils are disposed in slots, and a mold end wherein the end portions of the coils are formed through insulator molding;

the linear conductor portion of the stator core module comprises a first junction portion at a conductor end portion that is disposed protruding from the stator core toward the mold end side; and

the coil end portion of the mold end comprises a second junction portion at a conductor portion disposed protruding from an insulator toward the stator core module side;

having a step for bonding, through fusing, the first junction portion and the second junction portion.

The present invention enables the provision of a stator with a simple structure, wherein the height of the coil end portions is low. Moreover, the present invention enables the provision of a rotating electric machine provided with that stator. Furthermore, the present invention enables the provision of a vehicle provided with this rotating electric machine. Moreover, the present invention enables the provision of a method for manufacturing a stator wherein manufacturing can be performed easily.

### BRIEF DESCRIPTIONS OF THE DRAWINGS

FIG. 1 is an assembly perspective diagram illustrating an example of a stator of a rotating electric machine according to an example according to the present invention.

FIG. 2 is a diagram illustrating an example of a stator, wherein (a) is an assembly side view illustrating an example of a stator, and (b) is a side view illustrating an example of a stator.

FIG. 3 is a perspective diagram illustrating an example of a stator core module.

FIG. 4 is a plan view illustrating an example of a stator core module.

FIG. 5 is a diagram illustrating an example of a conductor portion of a mold end.

FIG. 6 is a diagram illustrating an example of a mold end.

FIG. 7 is a conceptual diagram for explaining an example of a vehicle equipped with a rotating electric machine according to an example according to the present invention.

### DETAILED DESCRIPTION

A stator of a rotating electric machine according to an example according to the present invention is equipped with coils that are interconnected through distributed winding onto a stator core of a rotating electric machine. This stator has a stator core module comprising a stator core wherein individual parts of linear conductor portions of coils are disposed in slots, and a mold end wherein coil end portions (the parts that are arranged exposed from the stator core) of the coils are formed through insulator molding. First junction portions are provided at conductor end portions that are disposed protruding toward the mold end side from the stator core. The coil end portions of the mold end are provided with second junction portions at conductor end portions that are disposed protruding from the insulator toward the stator core module side. The stator has a structure wherein first junction portions and second junction portions are joined.

That is, the stator is modularized through forming lead wire parts of the coil end portions of the distributed winding coils through insulator mold forming, and then joining, through fusing, such as welding or soldering, the first junction portions of the stator core module and the second junction portions of the mold ends.

The rotating electric machine is provided with this stator. The vehicle is provided with this rotating electric machine.

Examples according to the present invention will be explained below, in reference to the drawings. While the examples of the present invention include the detail in the drawings, there is no limitation thereto. Note that in the explanations of the various drawings below, those parts that are the same as parts already explained will be assigned identical reference symbols, and redundant explanations will be partially omitted.

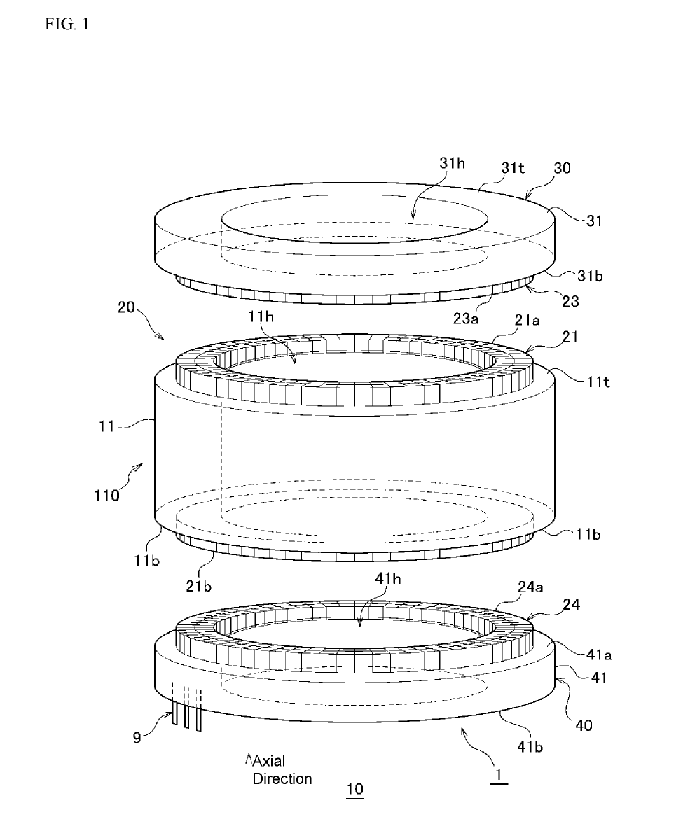

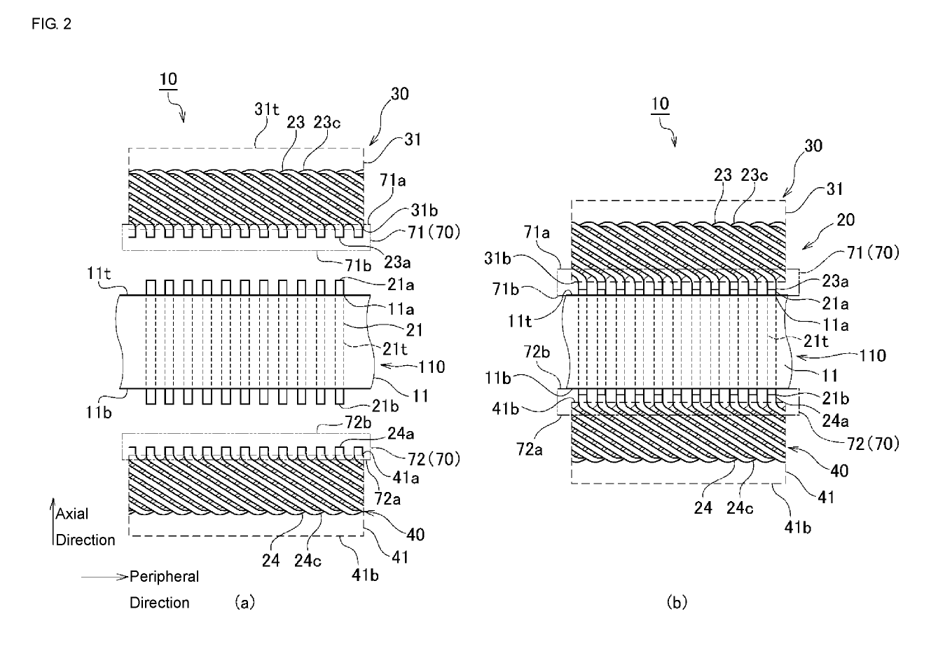

FIG. 1 is an assembly perspective diagram illustrating an example of a stator 10 of a rotating electric machine 1 according to an example according to the present invention. FIG. 2 illustrates an example of the stator 10. Specifically, FIG. 2 (a) is an assembly side view illustrating an example of the stator 10, and FIG. 2 (b) is a side view illustrating an example of the stator 10.

The stator 10 of the rotating electric machine one has a stator core module 110 and one or two mold ends wherein coil end portions of a coil are formed through insulator molding. In the present invention, the stator core 11 has two mold ends 30 and 40, having a structure wherein a stator core module 110 is disposed between the mold end 30 and the mold end 40.

The stator core module 110 has a stator core 11. The stator core 11 is formed in a round cylindrical shape that is provided with a hole portion 11h, along the axial direction, in the center portion thereof, with a plurality of slots 11a formed in the vicinity of the inner peripheral portion. One part 21t of a linear conductor portion 21 of a coil is disposed in a slot 11a.

Moreover, the linear conductor portion 21 of the stator core module 110 is provided with a junction portion 21a, at a conductor end portion that is disposed protruding toward the mold end 30 side from the end portion 11t (the top end portion) of the stator core 11, and provided with a junction portion 21b at a conductor end portion that is disposed protruding toward the mold end 40 side from an end portion 11b (bottom end portion) of the stator core 11.

The mold end 30 is disposed above the stator core module 110 (at the top in FIG. 1). The mold end 30 is formed through insulator mold forming using an insulator 31, such as a resin, of a bent conductor portion 23c of the coil end portion 23 of the coil. This mold end 30 is formed in a round cylindrical shape, and, specifically, is provided with a hole portion 31h extending along the axial direction from the center portion of the end portion 31t (the top end portion) to the center portion of the end portion 31b (the bottom end portion).

The coil end portion 23 of the mold end 30 is provided with a junction portion 23a at a conductor end portion that is disposed protruding toward the stator core module 110 side from the end portion 31b (the bottom end portion) of the insulator 31 of the mold end 30. This junction portion 23a of the mold end 30 is joined to the junction portion 21a of the stator core module 110.

In the present example, a plate-shaped insulator 71 (70), such as paper, is disposed in the vicinity of the junction portion 23a. This insulator 71 (70) functions as a thermally insulating member at the time of fusing of the respective junction portions, and as an insulating member between neighboring coils. Specifically, the top end portion 71a of the insulator 71 (70), through insulator molding, is embedded in the vicinity of an end portion 31b (the bottom end portion) of the insulator 31, such as resin, or the like, and the end portion 71b (the bottom end portion) of the insulator 71 (70) is provided so as to protrude farther toward the stator core module 110 side than the junction portion 23a. Note that the insulator 71 (70) may instead be monolithically molded from the same material as the insulator 31 (41).

The mold end 40 is disposed below the stator core module 110 (the bottom in FIG. 1). The mold end portion 40 is formed through insulator mold forming, using an insulator 41, such as resin, of the bent conductor portion 24c of the coil end portion 24 of the coil. This mold end 40 is formed in a round cylindrical shape, and, specifically, is provided with a hole portion 41h extending along the axial direction from the center portion of the end portion 41a (the top end portion) to the center portion of the end portion 41b (the bottom end portion).

The coil end portion 24 of the mold end 40 is provided with a junction portion 24a at a conductor end portion that is disposed protruding toward the stator core module 110 side from the end portion 41a (the top end portion) of the insulator 41 of the mold end 40. This junction portion 24a of the mold end 40 is joined to the junction portion 21b of the stator core module 110.

In the present example, a plate-shaped insulator 72 (70), such as paper, is disposed in the vicinity of the junction portion 24a. This insulator 72 (70), such as paper, functions as a thermally insulating member at the time of fusing of the respective junction portions, and as an insulating member between neighboring coils. Specifically, the bottom end portion 72a of the insulator 72 (70), through insulator molding, is embedded in the vicinity of an end portion 41a (top bottom end portion) of the insulator 41, such as resin, or the like, and the end portion 72b (the top end portion) of the insulator 72 (70) is provided so as to protrude farther toward the stator core module 110 side than the junction portion 24a. Note that the insulator 72 (70) may instead be monolithically molded from the same material as the insulator 41.

Moreover, in the present example, a plurality of terminals 9, that are connected electrically to the coils, are disposed protruding from the end portion 41b (the bottom end portion) of the insulator 41 of the mold end 40.

A rotor (not shown) of the rotating electric machine is disposed in the hole portion 31h of the mold end 30, the hole portion 11h of the stator core module 110, and the hole portion 41h of the mold end 40.

An example of a method for manufacturing the stator 10 will be explained.

The mold end 30 and the mold end 40 are fabricated through modularization through insulator mold forming, using an insulator such as resin, of the lead wire parts of the coil end portions of the distributed winding coil. A stator core module 110 is fabricated provided with a stator core 11 wherein individual parts of the linear conductor portions of the coils are disposed in slots.

Next, the junction portion 24a of the mold end 40 and the junction portion 21b of the stator core module 110 are joined through fusing. Following this, the junction portion 23a of the mold end 30 and the junction portion 21a of the stator core module 110 are joined through fusing.

At the time of this fusing, the insulator 71, such as paper, is disposed in the vicinities of the junction portions 23a and the junction portions 21a, and each of the junction portions are fused in a state wherein an insulator 72, such as paper, is disposed in the vicinities of the junction portions 24a and the junction portions 21b. When each of the junction portions has been joined, a coil group 20 is formed.

An example of a structure for a stator core module 110 will be explained in detail next.

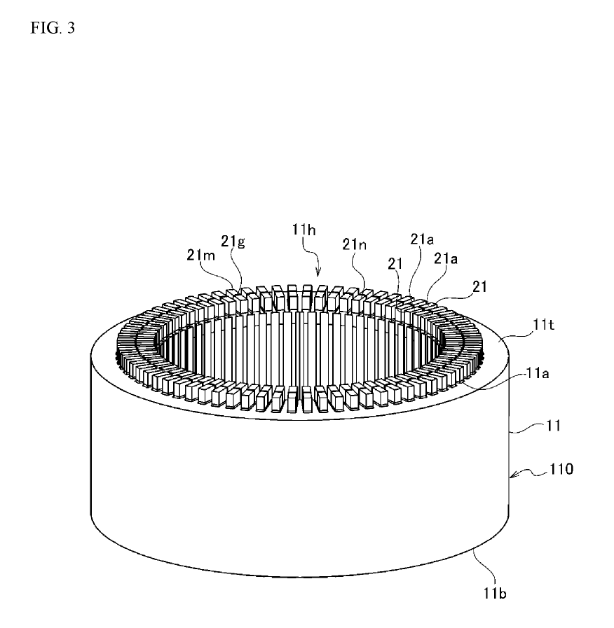

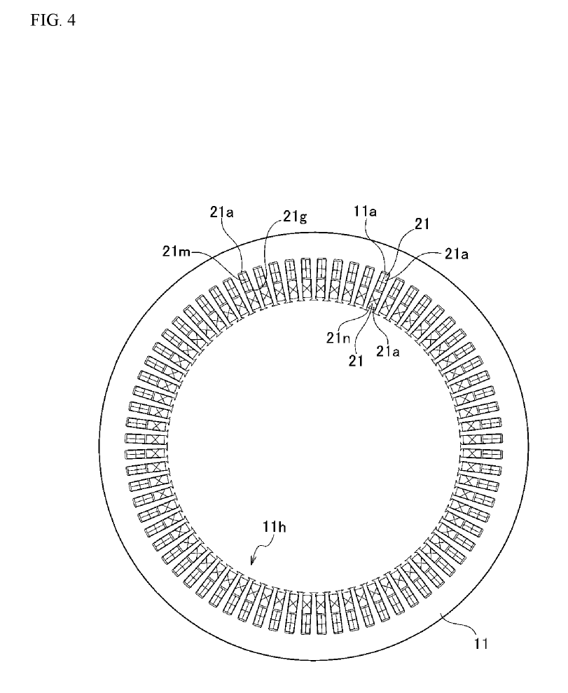

FIG. 3 is a perspective diagram illustrating an example of a stator core module 110. FIG. 4 is a plan view illustrating an example of a stator core module 110.

The stator core 11 is formed into a round cylindrical shape, and a hole portion 11h is provided in the center portion thereof, where a plurality of slots 11a that pass through, in the axial direction, is provided in the vicinity of the inner peripheral portion thereof. These slots 11a are formed at prescribed intervals along the circumferential direction of the inner periphery of the stator core 11. Moreover, these slots 11a are formed radiating in the radial direction.

A linear conductor portion 21 that is a rectangular wire that has a rectangular cross-section (a flat rectangular cross-section) that structures one part of a coil is inserted into, and held in, each of these slots 11a. Specifically, respective linear conductor portions 21 are provided on the inner peripheral side and the outer peripheral side in each of these slots 11a.

The junction portions 21a at the end portion of the linear conductor portion 21 at the inner peripheral side and the outer peripheral side are disposed so as to protrude from the end portions of the stator core 11, and gaps 21g are formed between each of the junction portions 21a.

Moreover, in the present example, 72 slots 11a (grooves) are formed in the stator core 11, and eight-pole windings are formed. In this case, the junction portions 21n of the outer peripheral side linear conductor portions that are disposed in the prescribed slots, and the junction portions 29 of the inner peripheral side linear conductor portions that are disposed in slots at positions spanning nine slots, are joined electrically through the conductors of the mold end 30.

Note that the stator is not limited to this form. For example, X slots 11a (grooves) may be formed in the stator core 11, and the north pole windings may be formed in and connected spanning M slots 11a.

The same is true for the bottom end side of the stator core 11 as well, where the junction portions of the end portions of the linear conductor portions 21 on the inner peripheral side and outer peripheral side are provided protruding from the end portions of the stator core, and gaps are formed between each of the junction portions.

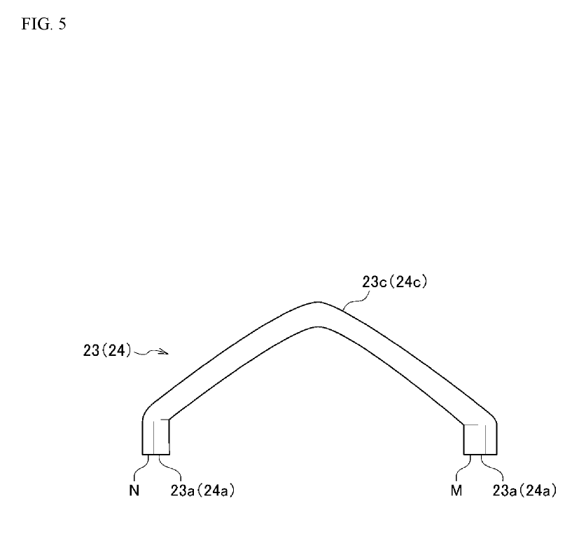

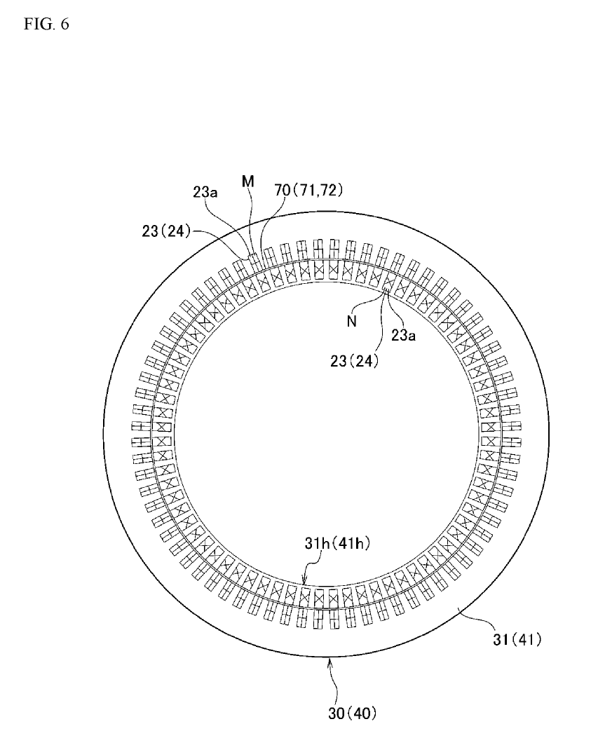

An example of the structure of the mold end will be explained in detail next. FIG. 5 is a diagram illustrating an example of a conductor portion at the mold end. FIG. 6 is a diagram illustrating an example of a mold end.

The mold end 30 (40) is formed through insulator mold forming, using an insulator 31 (41), such as resin, of a plurality of conductor portions of the coil end portion 23 (24) of the coil. The insulator 31 (41), such as resin, is formed into a round cylindrical shape, and a hole portion 31h (41h) is formed therein.

The coil end portion of the coil, as illustrated in FIG. 5, has a bent conductor portion 23c (24c), and a junction portion 23a (24a) is formed at the conductor end portion of the bent conductor portion 23c (24c).

In the present example, the bent conductor portion 23c (24c) is formed with a circular cross-sectional shape, but it may instead be formed with a rectangular cross-sectional shape. The junction portion 23a (24a) is formed in a rectangular cross-sectional shape. Each of the junction portions 23a (24a) is disposed in a respective position corresponding to a junction portion of the stator core module 110. Specifically, the junction portions 23a (24a) are disposed in two rows, on the inner peripheral side and the outer peripheral side at prescribed intervals along the circumferential direction of the inner periphery of the cylindrical insulator 31 (41).

Specifically, the junction portions M on one end of the coil end portions 23 (24) are disposed on the outer peripheral side, and the other junction portions N are disposed on the inner peripheral side, and are connected electrically by the bent conductor portions 23c (24c). In the present example, the junction portions N of the bent conductor portions 23c (24c) are positioned on the inner peripheral side at positions nine steps away, in the circumferential direction, using the junction portions M that are disposed at prescribed positions on the outer peripheral side as a reference. Note that the positions of the junction portions N and the junction portions M are specified in accordance with the winding aspect of the coils.

An insulator 70 (71, 72), such as paper, having a round cylindrical shape, is provided between the junction portions on the inner peripheral side and the junction portions on the outer peripheral side, that are disposed along the circumferential direction. At the time of fusing of the junctions, this insulator 70 (71, 72) with the round cylindrical shape is disposed in the gaps 21g between the junction portions 21a of the linear conductor portions 21 on the inner peripheral side and the outer peripheral side of the stator core module 110. In this way, round cylindrically shaped insulators 70 (71, 72) are disposed between each of the junction portions that are disposed on the inner peripheral side of the stator core module 110 and the mold end 30 (40) and each of the junction portions that are disposed on the outer peripheral side of the stator core module 110 and the mold end 30 (40).

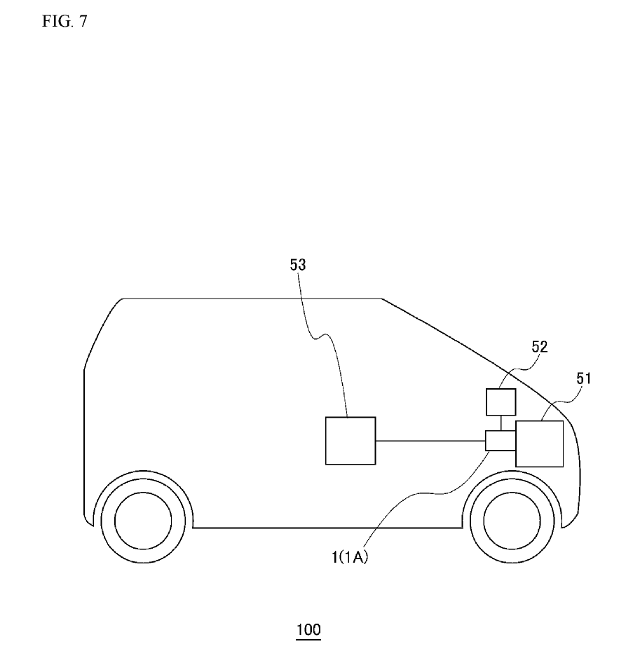

FIG. 7 is a conceptual diagram for explaining an example of a vehicle equipped with the rotating electric machine according to the example according to the present invention. The rotating electric machine 1 (1A) has a stator wherein the coils set forth above are disposed in distributed winding on page stator core, and a rotor (not shown), and the like. The vehicle 100 is provided with a rotating electric machine 1. Specifically, the vehicle 100, illustrated in FIG. 7, has an engine 51, a first battery 52, such as a lead battery, or the like, a secondary battery 53, such as a lithium ion battery, or the like, that is provided if necessary, a rotating electric machine 1 (1A), and so forth. The engine 51 and the rotor of the rotating electric machine 1 (1A) are connected by power transmitting means, such as a belt, so as to enable transmission of power therebetween. The first battery 52 and the secondary battery 53 are connected electrically to the rotating electric machine 1 (1A).

In the present example, the rotating electric machine 1 (1A) is used as an electric power generator with a motor function. The stator is small, and thus the rotating electric machine 1 (1A) is small as well. In the rotating electric machine 1 (1A), the rotor is rotated by the power of the engine, to generate electric power, which quickly charges the battery. When the engine 51 is started up (or restarted), the rotating electric machine 1 (1A) functions as a high-power starter. Moreover, when the vehicle accelerates, the rotating electric machine 1 (1A) provides motorized assistance to the engine 51.

Note that the vehicle 100 and the rotating electric machine 1 (1A) are not limited to the example set forth above.

As explained above, the stator 10 according to the example according to the present invention has coils that are interconnected in a distributed winding on the stator core 11 of the rotating electric machine 1. In the present example, the stator 10 has a coil group 20 comprising a plurality of coils. The stator 10 has a stator core module 110 that comprises a stator core 11 wherein individual parts of linear conductor portions 21 of coils are disposed in slots 11a, and a mold end 30 (40) wherein the end portions of the coils are formed through insulator molding.

Each linear conductor portion 21 of the stator core module 110 is provided with a junction portion 21a (21b) as a first junction portion at the conductor end portion that is disposed protruding from the stator core 11 toward the mold end 30 (40) side. Each coil end portion of the mold end 30 (40) is provided with a junction portion 23a (24a) as a second junction portion at the conductor end portion disposed protruding from the end portion of the insulator mold toward the stator core module 110 side. The stator 10 has a structure wherein the junction portions 21a (21b), as first junction portions, and junction portions 23a (24a), as second junction portions, are joined.

This makes it easy to provide a stator with a simple structure. Moreover, because the coil end portion of the mold end 30 (40) has a simple structure, the coil end portion can be formed with a small shape, and the stator is small.

A method for manufacturing a stator according to an example according to the present invention has a step for joining the first junction portions of the stator core module and the second junction portions of the coil end portions of the mold end 30 (40) through fusing. This joining may be joining through a prescribed fusing method, such as soldering, TIG welding, or the like. TIG welding is inert gas arc welding of a non-consumable-electrode type, where tungsten or a tungsten alloy is used in the electrode and argon gas, or the like, is used as a shield gas, to carry out welding while providing protection by isolating the arc and the molten metal from air. Moreover, a laser, or the like, may be used as the heating source for fusing instead.

Because of this, the distributed winding stator may be manufactured easily. Moreover, in an example according to the present invention, the plurality of second junction portions on the mold end is disposed with prescribed intervals along the circumferential direction in two lines, on the inner peripheral side and the outer peripheral side. The mold end has an insulator of a round cylindrical shape between the second junction portions on the inner peripheral side and the second junction portions on the outer peripheral side, where this round cylindrically shaped insulator is provided so as to protrude farther toward the stator core module than the second junction portions, from the end portion of the insulating mold.

At the time of fusing of the junctions, this insulator 70 (71, 72) with the round cylindrical shape is disposed in the gaps 21g between the junction portions 21a of the linear conductor portions 21 on the inner peripheral side and the outer peripheral side of the stator core module 110. In this way, round cylindrically shaped insulators 70 (71 and 72) are disposed between each of the junction portions that are disposed on the inner peripheral side of the stator core module 110 and the mold end 30 (40) and each of the junction portions that are disposed on the outer peripheral side of the stator core module 110 and the mold end 30 (40), making it possible to thermally and electrically insulate the junction portions on the inner peripheral side and the junction portions on the outer peripheral side.

Moreover, the rotating electric machine according to an example of the present invention is provided with the stator set forth above. Because of this, the motor, as a rotating electric machine, is small and has high power. Moreover, the power generator, as a rotating electric machine, is small and has high-power electrical generation. Moreover, a power generator with a motor function, as a rotating electric machine, is small and has high power, and also has high-power electrical generation.

Moreover, the vehicle according to the example according to the present invention is provided with a rotating electric machine as described above. When this rotating electric machine is used as a power generator, the space for installing in the vehicle can be kept small, enabling a battery that is installed in the vehicle to be charged quickly. Moreover, when the rotating electric machine is used as a motor, the space for installing in the vehicle can be kept small, enabling use as a high-power starter when starting (restarting) the engine. Moreover, when the vehicle is accelerating, providing motorized assistance to the engine can improve acceleration performance, reduce fuel consumption, and the like. Moreover, when the rotating electric machine is used as a power generator with a motor function, the space for installing in the vehicle can be kept small, enabling the battery to be charged rapidly, as described above, and making it possible to improve acceleration performance and reduce fuel consumption through motorized assistance at the time of starting up (or restarting) the engine and when the vehicle is accelerating.

While the examples of the present invention were described in detail referencing the drawings, the specific structures are not limited to those in these examples, but rather design changes, and the like, within a range that does not deviate from the spirit or intent of the present invention are included within the present invention.

Moreover, insofar as there are no particular contradictions or problems in purposes, structures, or the like, the details that are described for the examples illustrated in the various drawings described above may be combined.

Moreover, the details described in each of the drawings can be respectively independent examples, and the examples of the present invention are not limited to a single example combining each of the drawings.

What is claimed is:

1. A stator provided with coil that is wound by distributed windings on a stator core of a rotating electric machine comprising:
a stator core module comprising a stator core wherein one part of a linear conductor portion of the coil is disposed in a slot; and
a mold end, formed through insulator molding of a coil end portion of the coil,
wherein
the linear conductor portion of the stator core module comprises a first junction portion at a conductor end portion that is disposed protruding from the stator core toward the mold end side; and
the coil end portion of the mold end comprises a second junction portion at a conductor portion disposed protruding from an end portion of the insulator mold toward the stator core module side; and
a structure wherein the first junction portion and the second junction portion are joined.

2. The stator as set forth in claim 1, wherein
a plurality of second junction portions of the mold end is disposed at specific intervals along the circumferential direction in two lines, on the inner peripheral side and the outer peripheral side;
the mold end has a round cylindrically shaped insulator between a second junction portion on the inner peripheral side and a second junction portion on the outer peripheral side; and
the round cylindrically shaped insulator is disposed protruding further to the stator core module side than the second junction portion from the end portion of the insulating mold.

3. A rotating electric machine comprising a stator as set forth in claim 1.

4. A vehicle comprising a rotating electric machine as set forth in claim 3.

5. A manufacturing method of a stator provided with coil that is wound by distributed windings on a stator core of a rotating electric machine comprising:
the stator has a stator core module that comprises a stator core wherein individual parts of linear conductor portions of coils are disposed in slots, and a mold end wherein the end portions of the coils are formed through insulator molding;
the linear conductor portion of the stator core module comprises a first junction portion at a conductor end portion that is disposed protruding from the stator core toward the mold end side; and
the coil end portion of the mold end comprises a second junction portion at a conductor portion disposed protruding from an end portion of the insulator mold toward the stator core module side;
wherein the method further comprising a step of bonding the first junction portion and the second junction portion.

6. A method of manufacturing a stator, comprising the steps of:
providing coil wound by distributed windings on a stator core of a rotating electric machine;
disposing individual parts of linear conductor portions of coils in slots, and
forming a mold end and end portions of the coils through insulator molding;
forming, on the linear conductor portion of the stator core, a first junction portion at a conductor end portion;
disposing the first junction portion protruding from the stator core toward the mold end;
forming a second junction portion at a conductor portion of the coil end portion of the mold end;
disposing the second junction portion protruding from an end portion of the insulator mold toward the stator core; and
bonding the first junction portion and the second junction portion.
